(19) United States
(12) Patent Application Publication
(10) Pub. No.: US 2008/0299386 A1
(43) Pub. Date: Dec. 4, 2008

(54) Coatings

(76) Inventor: Andrew Frazer Simpson, Lancashire (GB)

Correspondence Address: MARSHALL & MELHORN, LLC, FOUR SEAGATE - EIGHTH FLOOR, TOLEDO, OH, 43604, US

(21) Appl. No.: 11/886,117

(22) PCT Filed: Mar. 9, 2006
(86) PCT No.: PCT/GB2006/000837

§ 371 Date: May 16, 2008

(30) Foreign Application Priority Data
Mar. 12, 2005 (GB) 0505074.5

(51) Int. Cl. B05D 5/06; B32B 5/00

(52) U.S. Cl. 428/336; 427/164

(57) ABSTRACT

A transparent substrate (10) having a visible light transmission of less than 60% and substantially the same hue in transmission and reflection comprises a coating upon at least one surface. The coating comprises a coloured layer (30) and an overcoat layer (20). The coloured layer (30) comprises a tin oxide and has a geometric thickness of less than 250 nm; the overcoat layer (20) has a geometric thickness of less than 50 nm, and at 540 m the refractive index of the overcoat layer (20) is higher than that of the coloured layer (30). The overcoat layer preferably comprises titania. The coatings may be applied using spray pyrolysis at a temperature above 500° C. The substrate is preferably a profiled glass sheet.

This invention relates to coated substrates and to methods for their production. In a preferred embodiment the substrate is a glass sheet, the coating comprises at least two layers and the coated glass sheet has the same hue both in transmission and reflection.

It is known in the art that applying a coating of a metal or metal oxide to the surface of a transparent substrate can modify the optical properties of the substrate. GB 1455148 discloses a method for pyrolytically forming a coating on a glass substrate to modify the light transmission and/or reflection to give the coated glass a tinted appearance when viewed by transmitted or reflected light. U.S. Pat. No. 6,423,414B1 discloses glass substrates that are coated with an antimony doped tin oxide main layer which has a geometric thickness of at least 250 nm and an outer reflective layer which has a geometric thickness ranging from 30 to 150 nm to create an improvement in the luminous reflectance of the coated glass. USP 2002/0182421A1 discloses coated glass substrates comprising a defined overcoat layer on a main layer comprising mainly tin oxide that have a reflectance of greater that 10% and high luminous transmittance.

Coatings comprising a tin oxide layer are used to produce a solar control glazing with low emissivity properties. Coatings comprising a tin oxide layer doped with fluorine are used to reduce the heat transmitted through a glazing whilst maintaining a high visible light transmission. Coatings comprising an antimony doped tin oxide layer are used to coat a transparent substrate to provide a solar control glazing. Antimony doped tin oxide has an absorption in the visible part of the spectrum thereby imparting a blue hue to the coated product.

Coating a transparent substrate with a coloured layer suffers from the effect of optical interference which can modify the reflected colour making it difficult to obtain the desired colour in both transmission and reflection. To avoid or at least alleviate the undesirable colour resulting from interference effects, a colour suppressing underlayer (which may itself be a combination of sub-layers) may be applied to the glass prior to deposition of the main layer, which may be tinted or not. The composition and deposition of such colour suppressing underlayers is described in prior published patents including GB 2 031 756B, UK 2 115 315B, U.S. Pat. No. 5,168,003 and EP 0 275 662B.

In certain circumstances it is desirable to produce a coated glass sheet that has substantially the same colour in both transmission and reflection. It is not always practical to provide the glass with a colour suppressing layer because processing conditions are not compatible with available precursors. This makes colour control of the coating in reflection particularly difficult, especially when substantially the same colour or hue is required both in transmission and reflection.

It is the principal objective of this invention to provide a coated substrate comprising at least two coating layers that has substantially the same hue in transmission and reflection that does not use a colour suppressing underlayer. Applicants have found that it is possible to modify the reflected colour of a substrate coated with a coloured layer by depositing a thinner overcoat layer having a higher refractive index than the tinted layer above the coloured layer. Accordingly from a first aspect this invention provides a coated substrate that has substantially the same hue in transmission and reflection which comprises a transparent substrate having a coating upon at least one surface, said coating comprising a coloured layer and an overcoat layer wherein the coloured layer comprises a tin oxide and has a geometric thickness of less than 250 nm; the overcoat layer has a geometric thickness of less than 50 nm, and at 540 nm the refractive index of the overcoat layer is higher than that of the coloured layer, characterised in that the coated substrate has a visible light transmission of less than 60%.

Preferably the hue is blue, green or red. It is preferred that the geometric thickness of the coloured layer is 50 to 240 nm, preferably 100 to 220 nm. The geometric thickness of the overcoat layer is preferably 5 to 40 nm, most preferably 10 to 25 nm.

The coloured tin oxide layer preferably comprises a dopant chosen from the group comprising antimony, yttrium and zinc. In a more preferred embodiment the coloured layer comprises antimony doped tin oxide. The preferred concentration of the dopant is in the range 5 to 30 mole %, most preferably 15 to 25 mole %.

The overcoat layer preferably comprises an oxide of titanium, hafnium, niobium, cerium or vanadium. In a preferred embodiment the overcoat layer is a titanium oxide.

Generally the coloured layer will be deposited onto a transparent substrate that is glass, preferably soda-lime-silica glass. It is preferred that the soda-lime-silica glass is in the form of a sheet preferably produced in a continuous process for example by a float process. In one preferred embodiment, the glass sheet is formed between a pair of rollers. Preferably the glass sheet has a thickness between 2 and 10 mm, preferably between 4 and 8 mm. It is preferred that the substrate is substantially flat. In a preferred embodiment the substrate comprises at least one bent portion with a fold line running substantially parallel to an edge of the sheet. A profiled glass sheet of this type may be formed form a ribbon of clear glass where both lateral edges are bent upwards after the sheet has been formed. A profiled glass product of this type is sold by Pilkington plc under its trade mark PROFILIT.

In a preferred embodiment the coloured layer is deposited directly onto a surface of the substrate and the overcoat layer is deposited directly onto the coloured layer. Such a coating is especially advantageous when used to coat a profiled glass sheet of the type disclosed above. After the edges of the glass sheet have been bent the two coatings may be applied to the glass whilst it is sufficiently hot to drive that deposition. The edges of the glass are normally bent upwards and the coating applied to the upper surface of the profiled glass.

The preferred visible light transmission of the coated substrate is preferably 25% to 55%, more preferably 30% to 40%. The preferred hue of the coated substrate viewed in transmission is blue, preferably having a b* in the range −15 to −1, most preferably −10 to −4 and a* in the range −3 to 3, preferably −1 to +1.

The preferred hue in reflection from the side having the coloured layer is blue, preferably having a b* in the range −20 to −1, most preferably −15 to −5 and a* in the range −5 to +1.

The coated substrate has a hue in reflection from the side without the coloured layer which is blue, preferably having a b* in the range −25 to −1, most preferably −20 to −10 and a* in the range −5 to +1.

It is preferred that the coated substrate has an a* in reflection from the side without the coloured layer that is similar to the a* obtained in reflection from the side having the coloured layer. Preferably the coated substrate has an a* in reflection from the side without the coloured layer that is ±2 of the a* obtained in reflection from the side having the coloured layer.

From a second aspect this invention provides a method of producing a coated substrate that has substantially the same hue in transmission and reflection which comprises depositing a coloured layer onto a transparent substrate by contacting said transparent substrate with a fluid mixture comprising a precursor of a tin oxide, depositing an overcoat layer by contacting the coated substrate with a fluid mixture comprising a suitable precursor so that at 540 nm the overcoat has a higher refractive index than the coloured layer.

The coloured layer or the overcoat layer can be applied by any chemical vapour deposition process. Pyrolytic processes such as spray pyrolysis are a convenient way of applying coatings to glass. In a preferred embodiment the coloured layer or the overcoat layer is deposited by spray pyrolysis.

The precursor for the coloured layer or the overcoat layer can be dissolved in a solvent which is then vapourised or sprayed onto the substrate. In the preferred embodiment wherein the coloured layer comprises a tin oxide the precursor of tin oxide comprises monobutyltintrichloride (MBTC). In the preferred embodiment wherein the coloured layer comprises an antimony doped tin oxide the precursor further comprises a precursor of antimony which is preferably antimony trichloride. The overcoat layer preferably comprises a metal oxide chosen from group comprising an oxide of titanium, hafnium, tantalum, niobium, cerium or vanadium. Preferably the overcoat layer comprises a titanium oxide. Suitable precursors of titanium oxide include a titanium alkoxide or titanium tetrachloride.

The heat of the substrate may provide a suitable source of the required energy so that a coating layer may be deposited on the substrate. Preferably the temperature of the substrate is at least 500° C., more preferably 550 to 700° C., most preferably 580 to 650° C.

The choice of substrate will affect the overall appearance of the coated substrate. By coating different substrates with different light transmission it is possible to produce coated substrates having a wide range of colours and light transmission values. The thickness of the substrate also affects the perceived colour of the coated substrate. Preferably the substrate will be 2 to 10 mm, most preferably 4 to 8 mm thick. Preferably the transparent substrate will be neutral, more preferably at 7 mm the substrate has a* in the range −7 and +2, b* in the range −3 to +3 and a visible light transmission of at least 25%, preferably between 30% and 90%.

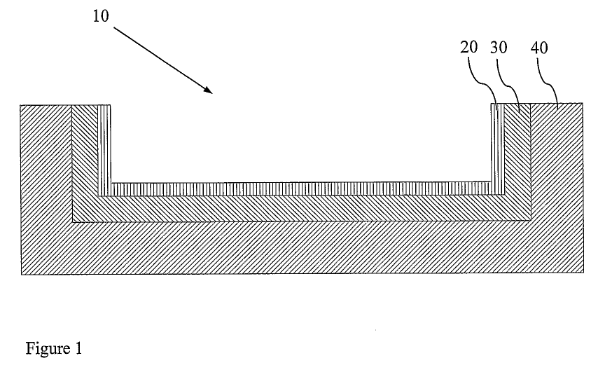

FIG. 1 shows a cross section (not to scale) of a coated glass sheet according to this invention. FIG. 1 comprises a coated sheet (10) comprising an overcoat layer (20) a coloured layer (30) and a substrate (40).

The terms colour and light transmission discussed herein are based on the standard definitions used in the CIE LAB system under illuminant D65 and 2° observer. The term hue used herein is taken to have the meaning given to it on page 533, volume 6 of the Kirk-Othmer encyclopaedia of chemical technology, 1979.

The invention is further described by the following examples.

### EXAMPLE 1

A coloured layer (30) of antimony doped tin oxide was deposited onto a clear soda-lime-silica glass sheet (40). The glass sheet was in the form of a ribbon 250 mm wide and 7 mm thick moving at a speed of 3.6 m/minute. The temperature of the glass just upstream of the coater was measured at about 630° C. by optical pyrometry. The liquid precursor was a mixture of monobutyltintrichloride (MBTC) and antimony trichloride (SbCl₃) dissolved in ethanol. The ratio by weight of MBTC to SbCl₃ in the precursor is about 4:1. The precursor was at least 70% by weight ethanol and not less than 20% by weight MBTC. The precursor liquid was sprayed onto the ribbon at a flow rate of 200 ml/minute.

Immediately after the coloured layer had been deposited, an overcoat layer (20) of titania was deposited from a precursor comprising the components shown in table 1.

TABLE 1

| Component | Concentration (% by weight) |
|---|---|
| 2-propanol | 5-10 |
| Titanium (IV) acetylacetonate | 20-50 |
| Xylene, mixture of isomers | 20-50 |
| Titanium tetraisopropanol | 5-10 |
| 2-butoxy-ethanol | 10-20 |

Other titanium alkoxide precursors could be used, for example titanium ethoxide. Additionally, titanium tetrachloride could be used. This precursor liquid was also sprayed onto the substrate at a flow rate of about 35 ml/minute.

A coated transparent substrate (10) was produced having an antimony doped tin oxide layer (30) having a geometric thickness of 200 nm and a titanium oxide overcoat layer (20) having a geometric thickness of 20 nm. The geometric thickness was determined by XPS profiling.

The coated transparent substrate had a blue hue in transmission and reflection. The optical properties obtained are given in table 2.

### COMPARATIVE EXAMPLE 2

A coloured layer of antimony doped tin oxide was deposited onto a clear soda-lime-silica glass sheet. The glass sheet was in the form of a ribbon 250 mm wide by 7 mm thick and was moving at a speed of 3.6 m/minute. The temperature of the glass just upstream of the coater was measured at about 630° C. by optical pyrometry. The liquid precursor was a mixture of monobutyltintrichloride (MBTC) and antimony trichloride (SbCl₃) dissolved in ethanol. The ratio by weight of MBTC to SbCl₃ in the precursor is about 4:1. The precursor was at least 70% by weight ethanol and not less than 20% by weight MBTC. The precursor liquid was sprayed onto the ribbon at a flow rate of 60 ml/minute. A coloured layer with a geometric thickness of 60 nm was obtained and the optical properties are given in table 2. There was no overcoat layer. The geometric thickness was determined by XPS profiling.

The coated substrate that was produced did not have the same hue in transmission and reflection and had high visible light transmission.

### COMPARATIVE EXAMPLE 3

A coloured layer of antimony doped tin oxide was deposited onto a clear soda-lime-silica glass sheet that was 7 mm thick using the same conditions as in example 2 except the precursor liquid was sprayed onto the ribbon at a flow rate of 170 ml/minute. A coloured layer with a geometric thickness of 200 nm was obtained and the optical properties are given in table 2. There was no overcoat layer. The geometric thickness was determined using electron microscopy.

The coated substrate that was produced did not have the same hue in transmission and reflection.

### COMPARATIVE EXAMPLE 4

A coloured layer of antimony doped tin oxide was deposited onto a clear soda-lime-silica glass sheet that was 7 mm thick using the same conditions as in example 2 except the precursor liquid was sprayed onto the ribbon at a flow rate of 185 ml/minute. A coloured layer with a geometric thickness of 225 nm was obtained and the optical properties are given in table 2. There was no overcoat layer. The geometric thickness was determined by electron microscopy.

The coated substrate that was produced had almost the same hue in transmission and reflection but was becoming too dark in transmission.

### EXAMPLE 5

A coated transparent substrate 7 mm thick was produced having an antimony doped tin oxide layer having a geometric thickness of 200 nm and a titanium oxide overcoat layer having a geometric thickness of 40 nm. The geometric thickness was determined using electron microscopy. The properties are given in table 2. The substrate was a clear soda-lime-silica glass sheet.

### EXAMPLE 6

A coated transparent substrate 7 mm thick was produced having an antimony doped tin oxide layer having a geometric thickness of 200 nm and a titanium oxide overcoat layer having a geometric thickness of 50 nm. The geometric thickness was determined using electron microscopy. The properties are given in table 2. The substrate was a clear soda-lime-silica glass sheet.

### EXAMPLE 7

A coated transparent substrate 7 mm thick was produced having an antimony doped tin oxide layer having a geometric thickness of 210 nm and a titanium oxide overcoat layer having a geometric thickness of 30 nm. The geometric thickness was determined by XPS profiling. The coloured layer had 17 mole % antimony determined using XPS. The properties are given in table 2. The substrate was a clear soda-lime-silica glass sheet.

### EXAMPLE 8

A coated transparent substrate 7 mm thick was produced having an antimony doped tin oxide layer having a geometric thickness of 210 nm and a titanium oxide overcoat layer having a geometric thickness of 30 nm. The geometric thickness was determined by XPS profiling. The coloured layer had 18 mole % antimony determined by XPS. The properties are given in table 2. The substrate was a clear soda-lime-silica glass sheet.

TABLE 2

| | | | | Reflection from | | | Reflection from | | |
|---|---|---|---|---|---|---|---|---|---|
| | Transmission | | | Uncoated Side | | | Coated Side | | |
| | % Transmission | A* | b* | % Reflection | a* | B* | % Reflection | a* | b* |
| Example 1 | 34.4 | 0.6 | −7.0 | 5.2 | 1.2 | −14.3 | 8.1 | −0.2 | −10.8 |
| Comparative | 62.0 | −1.9 | −1.0 | 13.5 | −2.9 | −5.6 | 19.0 | −1.0 | −3.0 |
| Example 2 | | | | | | | | | |
| Comparative | 35.9 | −0.9 | −8.3 | 5.1 | 6.0 | −13.9 | 7.0 | 4.0 | −12.3 |
| Example 3 | | | | | | | | | |
| Comparative | 30.2 | 0.5 | −11.4 | 5.6 | −1.0 | −11.8 | 8.2 | 0.0 | −8.1 |
| Example 4 | | | | | | | | | |
| Example 5 | 35.3 | −0.3 | −8.3 | 5.6 | 0.4 | −14.9 | 7.4 | −1.1 | −11.6 |
| Example 6 | 36.8 | 0.2 | −5.5 | 6.5 | −0.7 | −18.5 | 10.4 | −4.0 | −14.6 |
| Example 7 | 38.1 | 0.9 | −4.5 | 6.8 | −2.1 | −16.5 | 10.7 | −4.7 | −12.5 |
| Example 8 | 34.3 | 1.9 | −7.3 | 7.8 | −7.0 | −9.8 | 12.2 | −6.0 | −5.7 |

1-37. (canceled)

38. A coated substrate that has substantially the same hue in transmission and reflection which comprises a transparent substrate having a coating upon at least one surface said coating comprising a colored layer and an overcoat layer wherein the colored layer comprises a tin oxide and has a geometric thickness of less than 250 nm, the overcoat layer has a geometric thickness of less than 50 nm, at 540 nm the refractive index of the overcoat layer is higher than that of the colored layer, and the coated substrate has a visible light transmission of less than 60%.

39. A coated substrate according to claim 38 wherein the hue is blue, green or red.

40. A coated substrate according to claim 38 wherein the colored layer has a geometric thickness between 50 and 240 nm.

41. A coated substrate according to claim 38 wherein the overcoat layer has a geometric thickness of between 5 and 40 nm.

42. A coated substrate according to claim 38 wherein the colored layer comprises a dopant chosen from the group including antimony, yttrium and zinc.

43. A coated substrate according to claim 42 wherein the colored layer comprises antimony doped tin oxide.

44. A coated substrate according to claim 43 wherein the concentration of the dopant is in the range 5 to 30 mole %.

45. A coated substrate according to claim 38 wherein the overcoat layer comprises an oxide of titanium, hafnium, tantalum, niobium, cerium or vanadium.

46. A coated substrate according to claim 45 wherein the overcoat layer is comprised of a titanium oxide.

47. A coated substrate according to claim 38 wherein the transparent substrate is glass.

48. A coated substrate according to claim 47 wherein the glass is soda-lime-silica glass.

49. A coated substrate according to claim 48 wherein the soda-lime-silica glass is a sheet.

50. A coated substrate according to claim 49 wherein the glass sheet has been produced by a continuous process.

51. A coated substrate according to claim 50 wherein the glass sheet has been produced by the float process or formed between a pair of rollers.

52. A coated substrate according to claim 51 wherein the sheet is between 2 mm and 10 mm thick.

53. A coated substrate according to claim 52 wherein the sheet comprises at least one bent portion with a fold line running substantially parallel to an edge of said sheet.

54. A coated substrate according to claim 38 wherein the visible light transmission is 25% to 55%.

55. A coated substrate according to claim 38 wherein the hue of the coated substrate viewed in transmission is blue, having a b* in the range −15 to −1.

56. A coated substrate according claim 55 wherein the color of the substrate in transmission has a* in the range −3 to +3.

57. A coated substrate according to claim 38 wherein the hue in reflection from the side having the colored layer is blue, having a b* in the range −20 to −1.

58. A coated substrate according to claim 57 wherein the reflected color of the substrate from the side with the colored layer has a* in the range −5 to +1.

59. A coated substrate according to claim 38 wherein the hue in reflection from the side without the colored layer is blue, having a b* in the range −25 to −1.

60. A coated substrate according to claim 59 wherein the reflected color of the substrate from the side without the colored layer has a* in the range −5 to +1.

61. A coated substrate according to claim 60 wherein the reflected color of the substrate from the side without the colored layer has an a* that is ±2 of the a* obtained in reflection from the side with the colored layer.

62. A method of producing a coated substrate that has substantially the same hue in transmission and reflection which comprises depositing a colored layer onto a transparent substrate by contacting said transparent substrate with a fluid mixture comprising a source of tin oxide, after which an overcoat layer is deposited by contacting the substrate with a fluid mixture comprising a source of a metal oxide such that at 540 nm the overcoat has a higher refractive index than the colored layer.

63. A method according to claim 62 wherein the colored layer is deposited by atmospheric pressure chemical vapor deposition.

64. A method according to claim 63 wherein the colored layer is deposited by spray pyrolysis.

65. A method according to claim 62 wherein the source of tin oxide comprises monobutyltintrichloride.

66. A method according to claim 65 wherein said source of tin oxide further comprises a precursor of antimony.

67. A method according to claim 62 wherein the metal oxide of the overcoat layer is chosen from group consisting of an oxide of titanium, hafnium, tantalum, niobium, cerium and vanadium.

68. A method according to claim 67 wherein the metal oxide is a titanium oxide.

69. A method according to claim 68 wherein the source of titanium oxide comprises a titanium alkoxide or titanium tetrachloride.

70. A method according to claim 62 wherein the temperature of the substrate is at least 500° C.

71. A method according to claim 62 wherein the overcoat layer is deposited by atmospheric pressure chemical vapor deposition.

72. A method according to claim 62 wherein the overcoat layer is deposited by spray pyrolysis.
